(19) United States
(12) Patent Application Publication
(10) Pub. No.: US 2005/0154893 A1
(43) Pub. Date: Jul. 14, 2005

(54) Method for embedding codes, method and apparatus for restoring identification information

(76) Inventor: Hirofumi Muratani, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/002,660

(22) Filed: Dec. 3, 2004

(30) Foreign Application Priority Data
Dec. 5, 2003 (JP) 2003-407889

(51) Int. Cl. H04L 9/00

(52) U.S. Cl. 713/176

(57) ABSTRACT

According to the embodiments of the present invention, identification information that is embedded by the fingerprinting scheme cannot be read out by the third party, which can protect privacy of a user. Specifically, when converting an identification number u of a user to remainder codes <q₁, q₂, . . . , q_{N}>, and embedding thus obtained remainder codes into content information by digital watermark embedding processing, the identification number u or remainder codes <u₁, . . . , u_{N}> are encrypted based on a secret key s. Accordingly, even though the third party who does not know the secret key s improperly detects a digital watermark to obtain an encrypted identification number v, the valid identification number u before encryption cannot be obtained. Thus, privacy of the user can be protected.

### CROSS-REFERENCE TO RELATED APPLICATIONS

This application is based upon and claims the benefit of priority from prior Japanese Patent Application No. 2003-407889, filed Dec. 5, 2003, the entire contents of which are incorporated herein by reference.

### BACKGROUND OF THE INVENTION

1. Field of the Invention

The present invention relates to a method for embedding codes, a method and apparatus for restoring identification information.

2. Description of the Related Art

An object that is configured by digital data or a physical entity can have identification information written thereto depending on its configuration and modification, and later, pursuit is possible by reading out the identification information. The pursuit scheme of this kind of object is generally referred to as the fingerprinting scheme.

The object may be either of digital data and a physical entity. As digital data, for example, there are a moving picture, music, still image, program, and logic structure writing. On the other hand, as a physical entity, for example, there are a compound, mixture, DNA (deoxyribonucleic acid) and RNA (ribonucleic acid) including gene information, and protein.

The method of writing identification information is arbitrary. In case of digital content, an object can have identification information embedded thereinto by employing digital watermarking (for example, refer to document 1).

[document 1] “Information Hiding-technique for steganography and digital watermarking”, S. Katzenbeisser and Faibien A. P. Petitcolas, 2000.

On the other hand, in case of a physical entity, an object has its composition physically and chemically modified such that it is identifiable, thereby identification information can be embedded thereinto. Especially, in case of a physical entity including gene information, identification information can be embedded by performing gene recombination, displacement of base sequence, displacement of amino acid sequence of protein.

However, above-described fingerprinting scheme may be subject to conspiracy attacks by a plurality of malicious third parties. When receiving conspiracy attacks, respective objects having embedded therein identification information different from each other are compared, and identification information is falsified based on information concerning the difference of the comparison result, and pursuit is violated. For example, a malicious party may perform a conspiracy attack when distributing pirated editions of digital content.

On the other hand, in view of preventing such conspiracy attacks, there are proposed encoding methods which once encode identification information at the time of embedding the identification information, and embed thus obtained codes. As one of such encoding methods, there is known the c-secure CRT encoding (for example, refer to documents 2 and 3).

[document 2] H. Muratani, “A collusion-secure fingerprinting code reduced by Chinese remaindering and it s random-error resilience”, Proc. Fourth Information Hiding Workshop, IHW 2001, LNCS 2137, Springer-Verlag, 2001, p.303-315.

[document 3) Japanese Patent Application KOKAI Publication No. 2001-285623.

The c-secure CRT encoding has secure characteristics which can point out conspirators even though the encoding receives conspiracy attacks by c conspirators at most, and is configured by employing the CRT (Chinese Remainder Theorem).

In the c-secure CRT encoding and similar encoding, elements u of a set U of identification information are represented by a group of elements u₁, . . . , u_{N} of a plurality of sets Q₁, . . . , Q_{N}. The uᵢ is an element of a set Qᵢ. The set U and Q₁ may be determined that the set U=Z_{N} and set Qᵢ=Zₚᵢ. The Z_{N} is a set of non-negative integers less than N. The N is a non-negative integer that is large enough to identify a user. The pᵢ is a non-negative integer that is smaller than N.

However, under above-described encoding method, as is not a problem in general, according to the inventor of the present invention, it cannot be completely denied that a malicious third party may form a conspiracy, and detect a digital watermark of content so as to read out identification information from the content. Furthermore, in case identification information is read out and the identification information is user ID, privacy of a user corresponding to the user ID may be invaded.

### BRIEF SUMMARY OF THE INVENTION

An object of the present invention is to provide a method for embedding codes, a method and apparatus for restoring identification information, which can make identification information embedded by the fingerprinting scheme unreadable by the third party so as to protect privacy of a user.

According to a first aspect of the present invention, there is provided a method for embedding codes which encodes an identification number of a user to embed thus obtained codes into content information, including the steps of: preparing a secret key; converting the identification number to remainder codes composed of a plurality of remainders to represent the identification number by a remainder system; encrypting, during the conversion, the identification number or remainder codes based on the secret key; and embedding the remainder codes obtained by the conversion into content information by digital watermark embedding processing.

According to a second aspect of the present invention, there is provided a method for restoring identification information which restores an identification number from content information in which remainder codes after encryption processing is embedded as an embedding code which is generated by concatenating respective component codes, the encryption processing encrypting, when converting the identification number of a user to the remainder codes composed of a plurality of remainders to represent the identification number by the remainder system, the identification number or remainder codes, comprising preparing a secret key for decryption processing corresponding to the encryption processing; extracting an embedding code from the content information; dividing thus extracted embedding code into respective component codes; generating, for the respective component codes, a remainder pair representing the upper and lower limit of the remainder which thus divided each component code represents; restoring an identification number using the Chinese Remainder Theorem based on the generated respective remainder pairs; and decrypting, during the restoration, the respective remainder pairs or identification number based on the secret key.

According to a third aspect of the present invention, there is provided an encoding device which represents an identification number of a user in content information by remainder codes composed of a plurality of remainders by calculating remainders modulo a plurality of integers which are relatively prime respectively, comprising: a secret key storage device configured to store therein a secret key; and an encryption device configured to encrypt the identification number or remainder codes based on the secret key stored in the secret key storage device.

According to a fourth aspect of the present invention, there is provided an apparatus for embedding codes which embeds remainder codes composed of a plurality of remainders to represent an identification number of a user by the remainder system into content information as an embedding code in which respective component codes composed of successive strings of “1” and strings of “0” which represent the respective remainders are concatenated, comprising: a secret key storage device configured to store therein a secret key; a pseudorandom number generation device configured to generate a plurality of pseudorandom numbers based on the secret key stored in the secret key storage device; and an embedding device configured to embed the embedding code into content information by adding or subtracting the respective pseudorandom numbers to or from content information based on “1” or “0” of the embedding code.

According to a fifth aspect of the present invention, there is provided an apparatus for detecting codes which detects embedded remainder codes from content information in which remainder codes after encryption processing is embedded as an embedding code which is generated by concatenating respective component codes by digital watermark embedding processing, the encryption processing encrypting, when converting the identification number of a user to the remainder codes composed of a plurality of remainders to represent the identification number by the remainder system, the identification number or remainder codes, comprising: a code extraction device configured to extract an embedding code from the content information; a code division device configured to divide thus extracted embedding code into-respective component codes; a remainder pair generation device configured to generate, for the respective component codes, a remainder pair representing the upper and lower limit of the remainder which thus divided each component code represents; and a remainder pair code output device configured to output remainder pair codes composed of remainder pairs of the respective component codes.

According to a sixth aspect of the present invention, there is provided an apparatus for detecting codes which detects an embedding code from content information in which the embedding code is embedded by converting remainder codes composed of a plurality of remainders to represent an identification number of a user by the remainder system to the embedding code in which respective component codes composed of successive strings of “1” and strings of “0” which represent the respective remainders are concatenated, and by adding or subtracting pseudorandom numbers generated from a secret key in advance to or from the content information based on “1” or “0” of the embedding code comprising: a secret key storage device configured to store therein a secret key; a pseudorandom number generation device configured to generate a plurality of pseudorandom numbers based on the secret key stored in the secret key storage device; cross-correlation calculation device configured to calculate cross-correlation between content information in which the embedding code is embedded and the pseudorandom numbers; and an embedding code determination device configured to determine, based on the calculation result of the cross-correlation, whether the embedding code embedded in the content information is “1” or “0”.

According to the first and third aspects, when converting the identification number of the user to the remainder codes, and embedding thus obtained remainder codes into content information by digital watermark embedding processing, the identification number or remainder codes are encrypted based on the secret key. Thus, the identification information that is embedded by the fingerprinting scheme cannot be read out by the third party, which can protect privacy of the user.

According to the second and fifth aspects, the identification number or remainder codes are decrypted based on the secret key for decryption processing corresponding to the encryption processing of the first and third aspects. Therefore, the apparatus for restoring identification information can read out identification information in addition to the operations corresponding to the first and third aspects.

According to the fourth aspect, when embedding the remainder codes which represent the identification number of the user by the remainder system into content information as the embedding code including strings of “1” and strings of “0”, the pseudorandom numbers generated based on the secret key are added to or subtracted from the content information depending on the “1”, “0” of the embedding code. Thus, the identification information that is embedded by the fingerprinting scheme cannot be read out by the third party, which can protect privacy of the user.

According to the sixth aspect, “1”, “0” of the embedding code that is embedded in content information are determined based on the secret key for generating the pseudorandom numbers of the fourth aspect. Thus, the embedding code that is embedded by the fourth aspect can be read out from the content information.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A to 1C show classified schematic views indicative of respective embodiments of the present invention;

FIG. 2 shows a schematic view indicative of the configuration of a system for pursuing an object including an embedding apparatus and a pursuing apparatus according to the first embodiment of the present invention;

FIG. 3 shows a schematic view indicative of the configuration of the embedding apparatus of the first embodiment;

FIG. 4 shows a schematic view indicative of the configuration of the pursuing apparatus of the first embodiment;

FIG. 5 shows a schematic view indicative of the configuration of an embedding unit of the first embodiment;

FIG. 6 shows a schematic view indicative of the operation of a detection unit of the first embodiment;

FIG. 7 shows a schematic view indicative of the operation of a pursuing unit of the first embodiment;

FIG. 8 shows a schematic view indicative of the configuration of an embedding apparatus according to the second embodiment of the present invention;

FIG. 9 shows a schematic view indicative of the configuration of a pursuing apparatus of the second embodiment;

FIG. 10 shows a schematic view indicative of the configuration of an encryption unit of the second embodiment;

FIG. 11 shows a schematic view indicative of the configuration of an embedding apparatus according to the third embodiment of the present invention;

FIG. 12 shows a schematic view indicative of the configuration of a pursuing apparatus of the third embodiment; and

FIG. 13 to FIG. 15 show schematic views indicative of the configuration of embedding/pursuing apparatuses according to the fourth to sixth embodiments of the present invention.

### DETAILED DESCRIPTION OF THE INVENTION

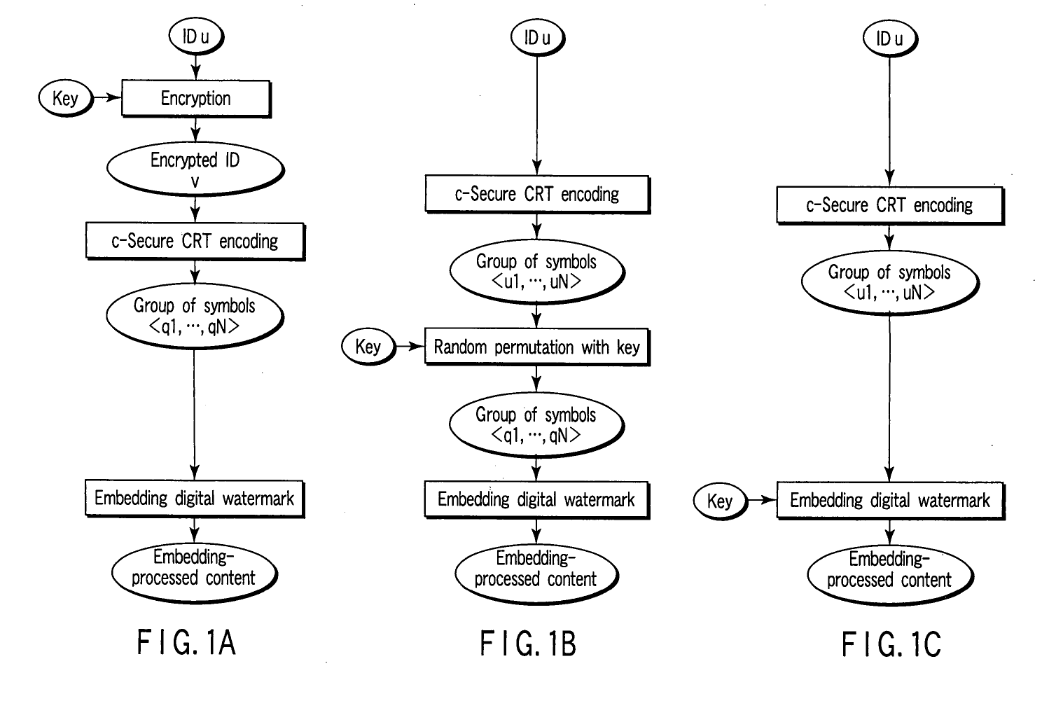

Referring to the accompanying drawings, embodiments of the present invention will be explained in detail. In the following respective embodiments, in order to prevent invasion of privacy, encryption is performed before identification information is embedded into an object to hide the identification information from the third party. Specifically, depending on the phase of performing encryption, there are broadly classified into three systems (A; FIG. 1A) to (C; FIG. 1C), as shown in FIG. 1A to FIG. 1C.

(A) Encrypting identification information, encoding thus encrypted identification information by the c-secure CRT encoding, and embedding thus obtained codes into content by digital watermarking (first and fourth embodiments).

(B) Encoding identification information by the c-secure CRT encoding, encrypting thus obtained codes, and embedding thus encrypted codes into content by digital watermarking (the second and fifth embodiments).

(C) Encoding identification information by the c-secure CRT encoding, and embedding thus obtained codes into content by digital watermarking that requires a key in detection (third and sixth embodiments).

In the respective systems (A) to (C), before embedding by digital watermarking, a group of symbols may be encoded in another way, which is not shown. For example, symbols are encoded to sequences of binary codes, and respective values in the sequences are embedded by digital watermarking.

Next, specifically, thus classified respective embodiments will be sequentially explained.

### FIRST EMBODIMENT

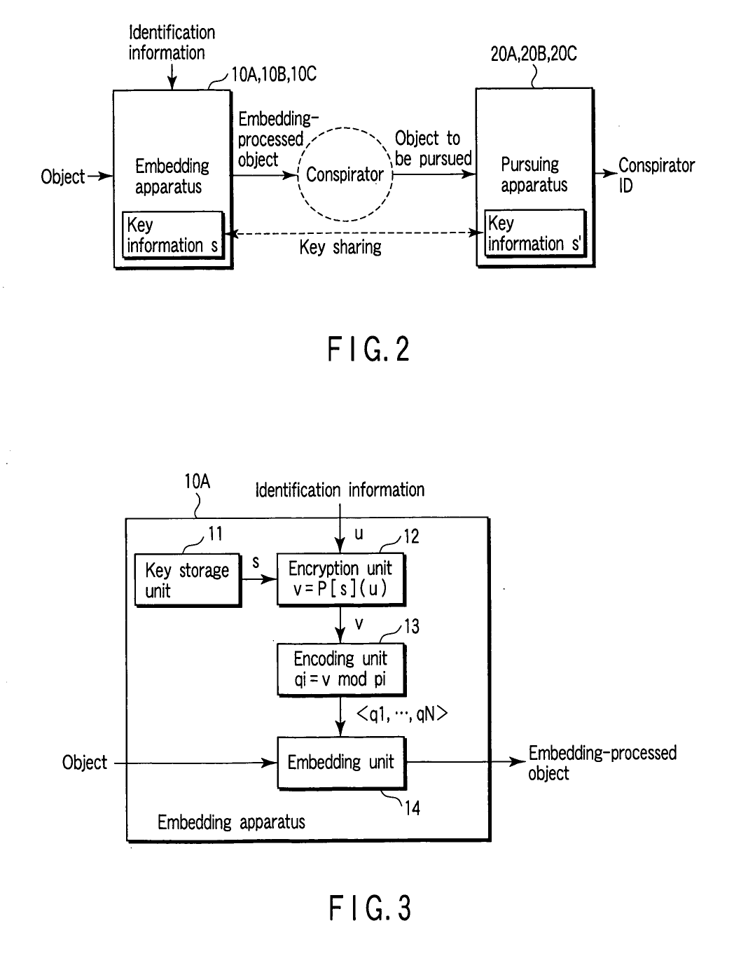

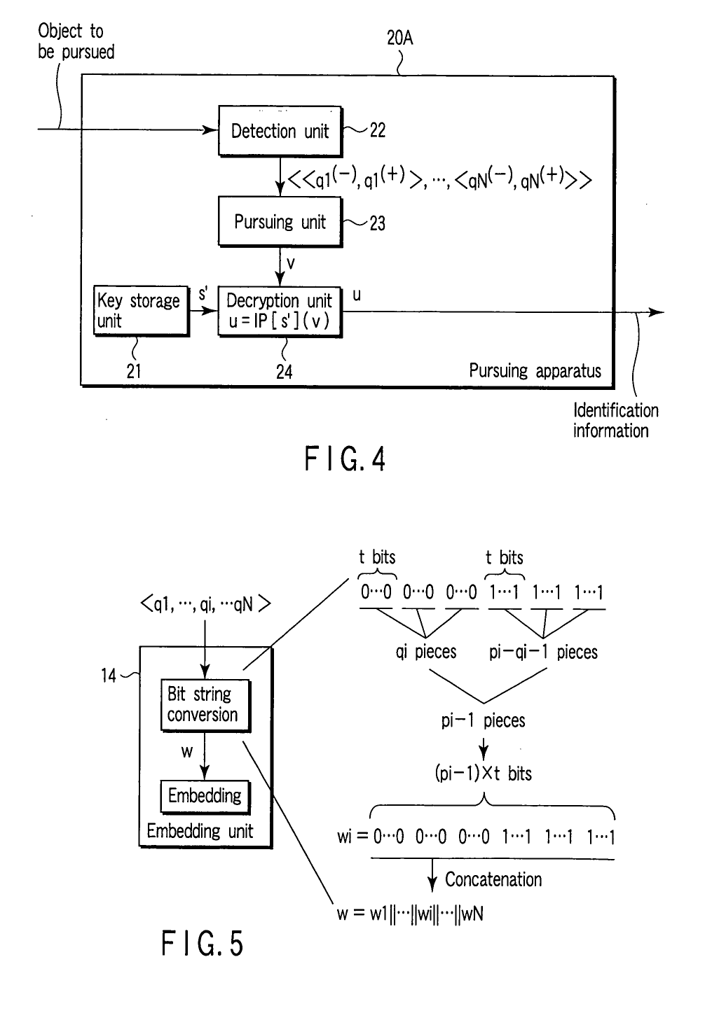

FIG. 2 shows a schematic view indicative of the configuration of a system for pursuing an object including an embedding apparatus and a pursuing apparatus according to the first embodiment of the present invention. FIG. 3 shows a schematic view indicative of the configuration of the embedding apparatus. FIG. 4 shows a schematic view indicative of the configuration of the pursuing apparatus. The object pursuing system shown in FIG. 2 includes an embedding apparatus (code embedding apparatus) 10A and a pursuing apparatus (identification information restoration apparatus) 20A.

In FIG. 2, in case key information s, s′ are of common key encryption, they are equal to each other (s′=s). In case key information s, s′ are of asymmetric key encryption, the key information s′ is a secret key s′ with respect to a public key s. Key sharing between the embedding apparatus 10A and the pursuing apparatus 20A can be realized by employing a key exchange protocol that uses key distribution by a reliable party or public key infrastructure, secret channel (dedicated line communication), handover between reliable parties, quantization encryption, mail that guarantees confidentiality, etc. In case that the embedding apparatus 10A and the pursuing apparatus 20A are arranged in an identical apparatus, the key information s, s′ can be shared in the apparatus without outputting them to outside.

The embedding apparatus 10A includes a key storage unit 11, an encryption unit 12, an encoding unit 13, and an embedding unit 14.

The key storage unit (secret key storage device) 11 is a memory that stores therein a secret key s, which can be read out by the encryption unit 12. The secret key s may be generated within the embedding apparatus 10A, or may be input or transmitted from outside.

The encryption unit (encryption device) 12 is provided with the function of encrypting an input identification number u of a user based on the secret key s stored in the key storage unit 11, and sending thus obtained identification number v to the encoding unit 13.

The encoding unit 13 has the function of calculating remainders qᵢ=v mod pᵢ (i=1, 2, . . . , N) modulo N pieces of integers {p₁, p₂, . . . , p_{N}} which are relatively prime respectively based on the identification number v sent from the encryption unit 12, the function-of representing the identification number v as remainder codes <q₁, q₂, . . . , q_{N}> composed of thus obtained N pieces of remainders {q₁, q₂, . . . , q_{N}}, and the function of sending the remainder codes to the embedding unit 14.

The embedding unit (embedding device) 14 embeds the remainder codes <q₁, q₂, . . . , q_{N}> sent from the encoding unit 13 into content information by digital watermark embedding processing. Specifically, the embedding unit 14 is provided with the function of generating N pieces of component codes w₁, w₂, . . . , w_{N} representing the respective remainders of the remainder codes, the function of concatenating the respective component codes to generate an embedding code w=w₁∥w₂∥. . . ∥w_{N}, and the function of embedding the embedding code w into content information by digital watermark embedding processing.

The component code wᵢ is composed of successive strings of “1” and strings of “0” with a predetermined number t of bits set to be one unit, as shown in FIG. 5. Under the c-secure CRT encoding, each remainder qᵢ is converted to the bit string wi composed of (qᵢ×t) pieces of “0” and following ((pᵢ−qᵢ−1)×t) pieces of “1”. The t is a predetermined parameter. The encoding unit 13 may be provided with the function of generating the component code wᵢ and the embedding code w.

In case of the c-secure CRT encoding, when the number of modulos is N, positive integer less than N is N′, positive integer equal to 2 or more is c, positive integer equal to 1 or more is z, the number of identification numbers which can be detected from the respective component codes at the time of detecting the embedding code is q, the relation of N≧c(N′+z)/2 is satisfied. Each component code wᵢ is a c-secure CRT code that can detect c identification numbers other than the identification number of the user from content information at the time of detecting the embedding code.

On the other hand, the pursuing apparatus 20A includes a key storage unit 21, a detection unit 22, a pursuing unit 23, and a decryption unit 24.

The key storage unit (secret key storage device) 21 is a memory that stores therein a secret key s′ for use to perform decryption processing corresponding to the encryption processing performed in the embedding apparatus 10A, which can be read out by the decryption unit 24. The secret key s′ may be transmitted from the embedding apparatus 10A by employing a key exchange protocol that uses public key infrastructure, or may be received by the operation of an operator.

The detection unit (code detection device) 22 is provided with the function of extracting the embedding code w from content information, the function of dividing the embedding code w into the respective component codes w₁, w₂, . . . , w_{N}, the function of generating, for the respective component codes, a remainder pair <qᵢ(−), qᵢ(+)> representing the upper and lower limit of the remainder qᵢ which each component code wᵢ represents, and the function of sending remainder pair codes <<q₁(−), q₁(+)>, . . . , <q_{N}(−), q_{N}(+)>> composed of remainder pairs of the respective component codes to the pursuing unit 23.

The pursuing unit (restoration device) 23 is provided with the function of calculating the identification number v using the Chinese Remainder Theorem based on each remainder pair <qᵢ(−), qᵢ(+)> of the remainder pair codes sent from the detection unit 22, the function of calculating the number of i which establishes a congruence (modulo pᵢ) between the identification number v and at least one remainder of each remainder pair <qᵢ(−), qᵢ(+)>, and the function of sending the identification number v to the decryption unit 24 when the number of i is larger than a threshold value Dₜₕ.

For example, the pursuing unit 23 calculates the number of i which establishes v≡qᵢ(−) (mod pᵢ) or v≡qᵢ(+)(mod pᵢ) for each identification number v being a pursuit candidate with respect to the respective remainder pairs q₁(−), q₁(+), . . . , q_{N}(−) q_{N}(+), and sends the identification number v to the decryption unit 24 when thus obtained number of i is larger than a threshold value Dₜₕ.

The threshold value Dₜₕ is “k+z” that satisfies the following inequality disclosed in claim 10 and mathematical formula (1) of the document 3.

$${[ 1 - {\prod }_{i = 1}^{z} \{ 1 - {( 1 - \frac{1}{{p}_{i}} )}^{c} \} ]}^{c ( k + z ) / {2}^{{c}_{i} + {zx2}^{k + z}}} \geq 1 - \frac{ɛ}{2}$$

It is noted that k′ in the document 3 is N (=number of modulos) in the present specification, while k in the document 3 is N′ (=positive integer less than N) in the present specification. Accordingly, the Dₜₕ=N′+z.

The decryption unit (decryption device) 24 is provided with the function of decrypting the identification number v sent from the pursuing unit 23 based on the secret key s′ stored in the key storage unit 21 so as to restore the identification number u.

Next the performance of thus configured object pursuing system will be explained.

<Processing at the Embedding Apparatus 10A Side>

It is assumed that content information as an object into which the identification number u is to be embedded and the identification number u as an element u that belongs to a set U of identification numbers are transmitted to the embedding apparatus 10A.

The encryption unit 12 encrypts thus input identification number u based on the secret key s stored in the key storage unit 11, and sends thus obtained identification information v to the encoding unit 13. The method of encryption processing is arbitrary, and in case of the AES (Advanced Encryption Standard) disclosed in the document 4, the set U of identification numbers satisfies the relation of U=Z₂128.

[document 4] “The Federal Information Processing Standard (FIPS) for the Advanced Encryption Standard”, FIPS-197.

The secret key s is selected from a key space K=Z¹²⁸. Details of the encryption processing are written in the document 4. In the encryption processing, bijective mapping P[s] is given from the set U to V of identification numbers.

The encoding unit 13 encodes the received identification number v, and sends thus obtained remainder codes to the embedding unit 14. At this time, the c-secure CRT encoding is employed. Details of the encoding are disclosed in the documents 2 and 3. It is determined that a set of remainders Qᵢ=Zₚᵢ, and the modulo pᵢ is selected as a positive integer which are relatively prime satisfying P₁<P₂<. . . <P_{N}. That is, the encoding unit 13 divides the identification number v by the modulo pi to calculate the remainders qᵢ=u mod Pᵢ, and sends the remainder codes <q₁, q₂, . . . , q_{N}> composed of thus obtained N pieces of remainders q₁, q₂, . . . , q_{N} to the embedding unit 14.

The embedding unit 14 converts the remainder codes to c-secure CRT codes. Specifically, each remainder qᵢ of the remainder codes is converted to the component code wᵢ or bit string composed of (qᵢ×t) pieces of “0” and following ((pᵢ−qᵢ−1)×t) pieces of “1”. Next, the embedding unit 14 concatenates the respective component codes wᵢ to generate the embedding code w=w₁∥w₂∥. . . ∥w_{N}.

The embedding unit 14 embeds respective bits of the embedding code w into content information as a digital watermark. There are a wide variety of specific digital watermarking systems (refer to the document 1). The present invention can employ an. arbitrary digital watermarking system.

Next, a specific digital watermarking system will be explained. It is assumed that content information is grayscale picture data. The embedding unit 14 selects a plurality of predetermined M pixels from the picture data every bit of the embedding code w, and changes pixel values Yj (j=1, 2, . . . , M) to Yj′. In case of embedding “0”, it is determined that changed pixel values Yj′=Yj+rj. In case of embedding “1”, it is determined that changed pixel values Yj′=Yj−rj. The rj are random numbers.

When the embedding code w is embedded, the embedding unit 14 outputs content information in which the embedding code w is embedded.

<Processing at the Pursuing Apparatus 20A Side>

It is assumed that content information as an object to be pursued is transmitted to the pursuing apparatus 20A. The detection unit 22 detects the embedding code w embedded in the content information. It is also assumed that the object is grayscale picture data.

The detection unit 22 selects a plurality of predetermined (M) pixels from the picture data every bit of the embedding code w, and calculates cross-correlation between pixel values Yj (j=1, 2, . . . , M) and random numbers rj used in embedding processing. The random numbers rj are given to the pursuing apparatus 20A in advance.

The detection unit 22 determines that “0” is embedded when thus calculated cross-correlation is larger than a predetermined upper limit, and “1” is embedded when the cross-correlation is smaller than a predetermined lower limit.

The detection unit 22 divides thus obtained embedding code w into components, whose size is equal to that at the time of embedding, to obtain N pieces of component codes w₁, w₂, . . . , w_{N}.

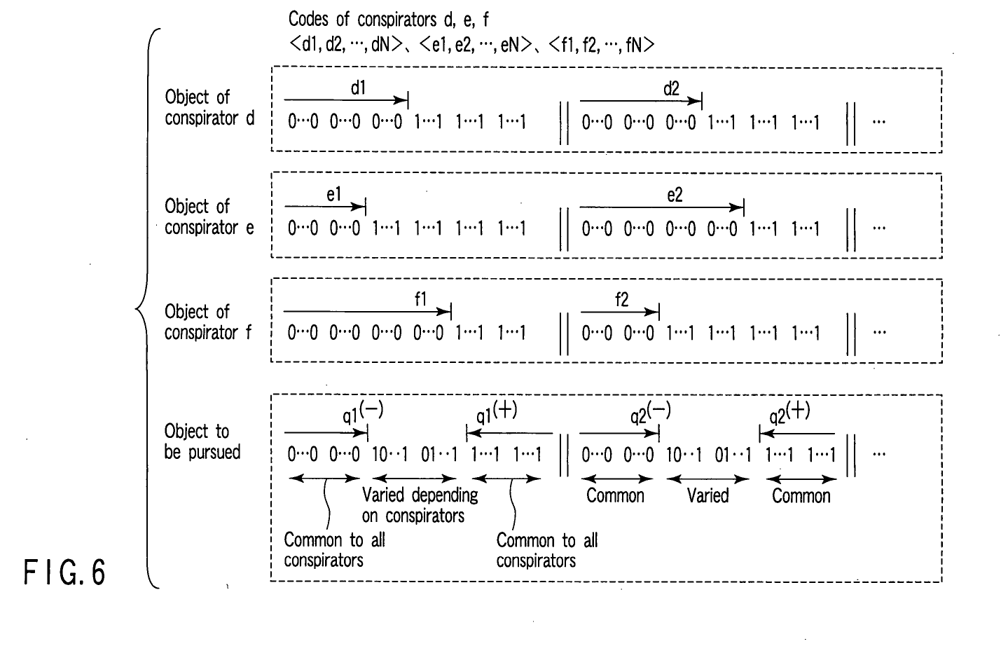

As shown in FIG. 6, the detection unit 22 sequentially detects blocks each composed of t bits from the left side of the bit string of component code wᵢ every component code wᵢ, and, when detecting a block which includes a value other than “0”, sets the number of blocks located on the left side thereof to be qᵢ(−). Similarly, the detection unit 22 sequentially detects blocks each composed of t bits from the right side of the bit string of component code wᵢ, and, when detecting a block which includes a value other than “1”, sets the number of blocks located on the right side thereof to be pᵢ−qᵢ(+)−1. Thus, the remainder pair qᵢ(−), qᵢ(+) is determined for each component code wᵢ.

When remainder pairs <q₁(−), q₁(+)>, <q_{N}(−). q_{N}(+)> are obtained for all the component codes w₁ to w_{N}, the detection unit 22 sends the remainder pair codes <<q₁(−), q₁(+)>, . . . , <q_{N}(−), q_{N}(+)>> composed of the remainder pairs to the pursuing unit 23.

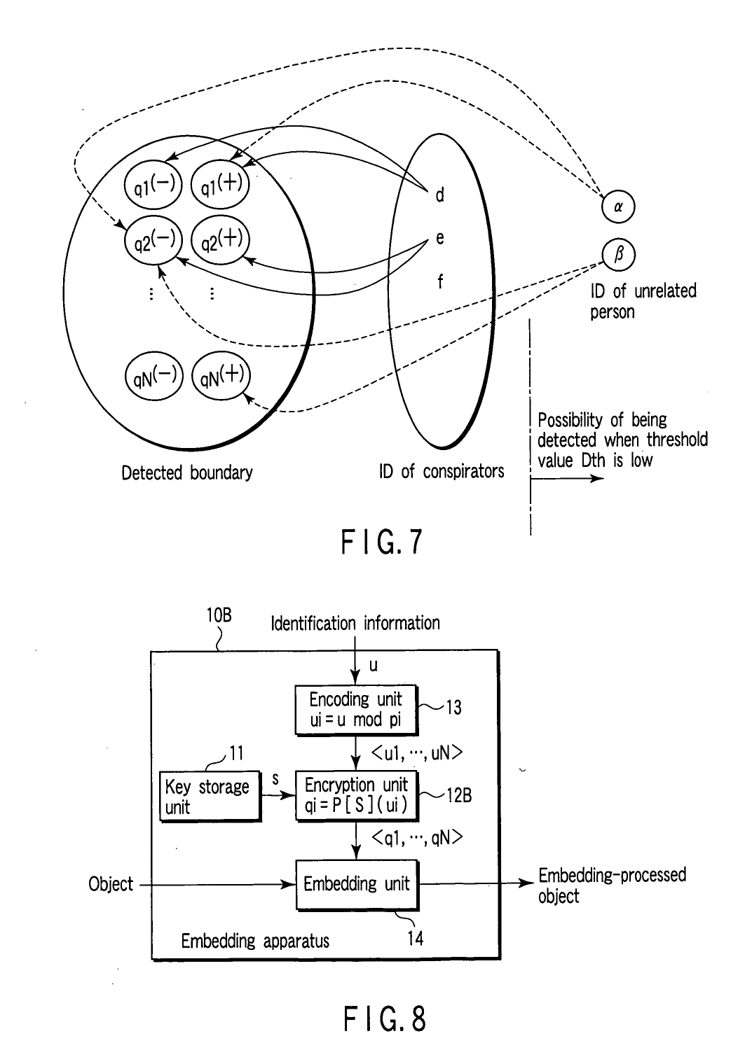

The pursuing unit 23 calculates the number of i which establishes v≡r(−)i(mod pᵢ) or v≡r(+)i (mod pᵢ) for each identification number v being pursuit candidate based on the respective remainder pairs <q₁(−), q₁(+)>, . . . , <q_{N}(−), q_{N}(+)> of the remainder pair codes. The pursuing unit 23 sends the identification number v to the decryption unit 24 when the number of i is larger than the threshold value Dₜₕ. As shown in FIG. 7, the threshold value Dₜₕ is made large to detect an identification number (ID) of a conspirator as well as exclude identification numbers (ID) of unrelated persons.

The decryption unit 24 decrypts the identification number v sent from the pursuing unit 23 based on the secret key s′ stored in the key storage unit 21, and outputs thus restored identification number u as pursued identification information u. The decryption processing IP[S′] is the inverse mapping of the bijective mapping P[s] at the time of encryption processing.

According to above-described embodiment, when converting the identification number u of the user to the remainder codes <q₁, q₂, . . . , q_{N}>, and embedding thus obtained remainder codes into content information by digital watermark embedding processing, the identification number u is encrypted based on the secret key s in advance. Thus, the identification information u that is embedded by the fingerprinting scheme cannot be read out by the third party, which can protect privacy of the user.

For example, even though the third party who does not know the secret key s improperly detects a digital watermark to obtain an encrypted identification number v, the valid identification number u before encryption cannot be obtained. Thus, privacy of the user can be protected.

When embedding codes, which are obtained by performing encoding which has resistance to conspiracy attacks, into an object, encryption which does not lower capability of pursuing the codes is performed. Accordingly, embedded identification number is kept secret, and privacy of the user corresponding to the identification number can be protected.

In above-described embodiment, identification number is decrypted based on the secret key s′ for decryption processing corresponding to encryption processing. Therefore, the pursuing apparatus 20A can read out identification number from content information.

### SECOND EMBODIMENT

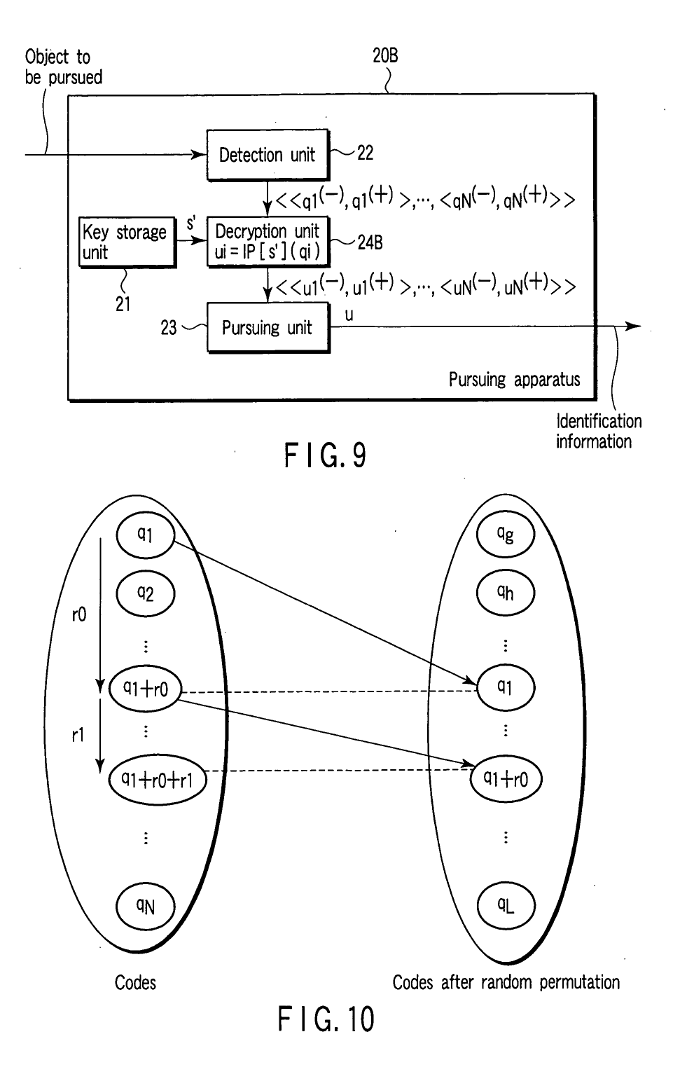

FIG. 8 shows a schematic view indicative of the configuration of an embedding apparatus according to the second embodiment of the present invention, while FIG. 9 shows a schematic view indicative of the configuration of a pursuing apparatus according to the same embodiment. In the second embodiment, parts or components similar to those of the first embodiment are indicated with the same reference numerals and detailed explanations of which will be omitted, and parts or components different from those of the first embodiment will be mainly explained. In the following respective embodiments, redundant explanations will be omitted. An embedding apparatus 10B shown in FIG. 8 and a pursuing apparatus 20B shown in FIG. 9 configure a system for pursuing an object, as is similar to that shown in FIG. 2.

That is, the second embodiment is the variation of the first embodiment, in which the remainder codes are encrypted instead of encrypting the identification number u.

Accordingly, the embedding apparatus 10B includes an encryption unit 12B, instead of above-described encryption unit 12, which is arranged between the encoding unit 13 and the embedding unit 14. The encoding unit 13 and the embedding unit 14 have their arrangement relation with respect to the encryption unit varied, and have the same functions as those explained above.

When receiving remainder codes <u₁, . . . , u_{N}> to represent the identification number u, which is not encrypted, by the remainder system from the encoding unit 13, the encryption unit (encryption device) 12B encrypts the remainder codes based on the secret key s stored in the key storage unit 11, and sends thus encrypted remainder codes <q₁, . . . , q_{N}> to the embedding unit 14.

This encryption processing P[s] is required not to lower capability of pursuing codes. For example, in view of not diminishing the respective remainders of the remainder codes, it is desired that the encryption processing employs a system in which encryption is performed for each set Qᵢ of the remainders. That is, the encryption processing P[s] is represented by bijective mapping Pᵢ[s] for each set Qᵢ of the remainders. Each Pᵢ[s] can be realized by deformation employing block encryption or deformation which varies the bit length according to need. In this embodiment, as encryption processing, the random permutation processing is employed, in which the remainders q₁, . . . , q_{N} are randomly permutated based on pseudorandom numbers r0, r1, . . . , as shown in FIG. 10. In the random permutation processing, a code corresponding to the remainder q₁ is permutated to a code corresponding to the remainder q₁+r0. After this, when a code corresponding to the remainder qᵢ−1 is permutated to a code corresponding to the remainder qⱼ, a code corresponding to the next remainder qᵢ is permutated to a code corresponding to the rᵢ-th remainder that is pseudorandom-number-rᵢ-th counted from the remainder qⱼ. At this time, codes which are permutated codes already are skipped. The count value i is increased one-by-one, repeating the random permutation processing until i=N.

On the other hand, the pursuing apparatus 20B includes a decryption unit 24B, instead of above-described decryption unit 24, which is arranged between the detection unit 22 and the pursuing unit 23. The detection unit 22 and the pursuing unit 23 have their arrangement relation with respect to the decryption unit 24B varied, and have the same functions as those explained above.

The decryption unit (decryption device) 24B decrypts the remainder pair codes <<q₁(−), q₁(+)>, <q_{N}(−), q_{N}(+)>> sent from the detection unit 22 based on the secret key s′ stored in the key storage unit 21, and sends thus obtained remainder pair codes <<u₁(−), u₁(+)>, . . . , <u_{N}(−), u_{N}(+)>> to the pursuing unit 23. The decryption processing IPᵢ[S′] is the inverse permutation processing of the encryption processing Pᵢ[s] by the embedding apparatus 10B.

Next, the performance of thus configured object pursuing system will be explained.

<Processing at the Embedding Apparatus 10B Side>

It is assumed that content information as an object into which the identification number u is to be embedded and the identification number u as an element u that belongs to a set U of identification numbers are transmitted to the embedding apparatus 10B.

The encoding unit 13 encodes thus input identification number u, and sends thus obtained remainder codes <u₁, u₂, . . . , u_{N}> to the encryption unit 12B.

The encryption unit 12B encrypts the remainder codes <u₁, u₂, . . . , u_{N}> based on the secret key s stored in the key storage unit 11, and sends thus obtained remainder codes <q₁, q₂, . . . , q_{N}> to the embedding unit 14.

Then, similar to the first embodiment, the embedding unit 14 embeds the remainder codes, as the embedding code w in which the respective component codes wᵢ are concatenated, into content information by digital watermark embedding processing. When the embedding code w is embedded, the embedding unit 14 outputs content information in which the embedding code w is embedded.

<Processing at the Pursuing Apparatus 20B Side>

It is assumed that content information as an object to be pursued is transmitted to the pursuing apparatus 20B. Similar to the above-described embodiment, the detection unit 22 detects the embedding code w embedded in the content information, and obtains the remainder pair codes <<q₁(−), q₁(+)>, <q_{N}(−), q_{N}(+)>> composed of the remainder pairs <q₁(−), q₁(+)>, . . . , <q_{N}(−), q_{N}(+)> for all the component codes w₁ to w_{N} of the embedding code w.

Then, the detection unit 22 sends the remainder pair codes <<q₁(−), q₁(+)>, . . . , <q_{N}(−), q_{N}(+)> to the decryption unit 24B.

The decryption unit 24B decrypts the remainder pair codes <<q₁(−), q₁(+)>, . . . , <q_{N}(−), q_{N}(+)>> based on the secret key s′ stored in the key storage unit 21, and sends thus obtained remainder pair codes <<u₁(−), u₁(+)>, . . . , <u_{N}(−), u_{N}(+)>> to the pursuing unit 23.

Then, as in the same manner described above, the pursuing unit 23 calculates the identification number u being a pursuit candidate using the Chinese Remainder Theorem based on the respective remainder pairs <u₁(−), u₁(+)>, . . . , <u_{N}(−), u_{N}(+)> of the remainder pair codes.

Then, the pursuing unit 23 calculates the number of i which establishes u≡r(−)i(mod pᵢ) or u≡r(+)i (mod pᵢ) for each identification number u being a pursuit candidate, and outputs the identification number u when the number of i is larger than the threshold value Dₜₕ.

According to the present embodiment described above, when converting the identification number u of the user to the remainder codes <q₁, q₂, . . . , q_{N}>, and embedding thus obtained remainder codes into content information by digital watermark embedding processing, the remainder codes <u₁, u₂, . . . , u_{N}> are encrypted based on the secret key s. Thus, the identification information u that is embedded by the fingerprinting scheme cannot be read out by the third party, which can protect privacy of the user.

For example, even though the third party who does not know the secret key s improperly detects a digital watermark to obtain an encrypted identification number v, the valid remainder codes <u₁, u₂, . . . , u_{N}> before encryption cannot be obtained, thereby the valid identification information cannot be obtained. Thus, privacy of the user can be protected from the third party.

When embedding codes, which are obtained by performing encoding which has resistance to conspiracy attacks, into an object, encryption which does not lower capability of pursuing the codes is performed. Accordingly, embedded identification number is kept secret, and privacy of the user corresponding to the identification number can be protected.

In the above-described embodiment, remainder codes are decrypted based on the secret key s′ for decryption processing corresponding to encryption processing. Therefore, the pursuing apparatus 20B can read out identification number from content information.

Above-described effects are similar to those of the first embodiment to this point. Next, effects peculiar to the second embodiment will be explained. According to the second embodiment, especially, resistance to random errors relative to codes can be improved. This is because weak ID (weak identification number) can hardly exist as a result of the random permutation processing for the Qᵢ by encryption processing. In the c-secure CRT encoding, the weak ID is wrongly pursued with high probability when random errors are added into codes.

In the c-secure CRT encoding, an identification number of small value tends to be weak ID. An identification number of small value is represented by a group of integers of small value. When random errors are added into codes, codes which include many groups of integers of small value are detected with high probability. When an identification number of small value undergoes the random permutation processing, the probability of being represented by a group of integers of small value is lowered. So, even if random errors are added into codes, the probability of being wrongly pursued is lowered.

### THIRD EMBODIMENT

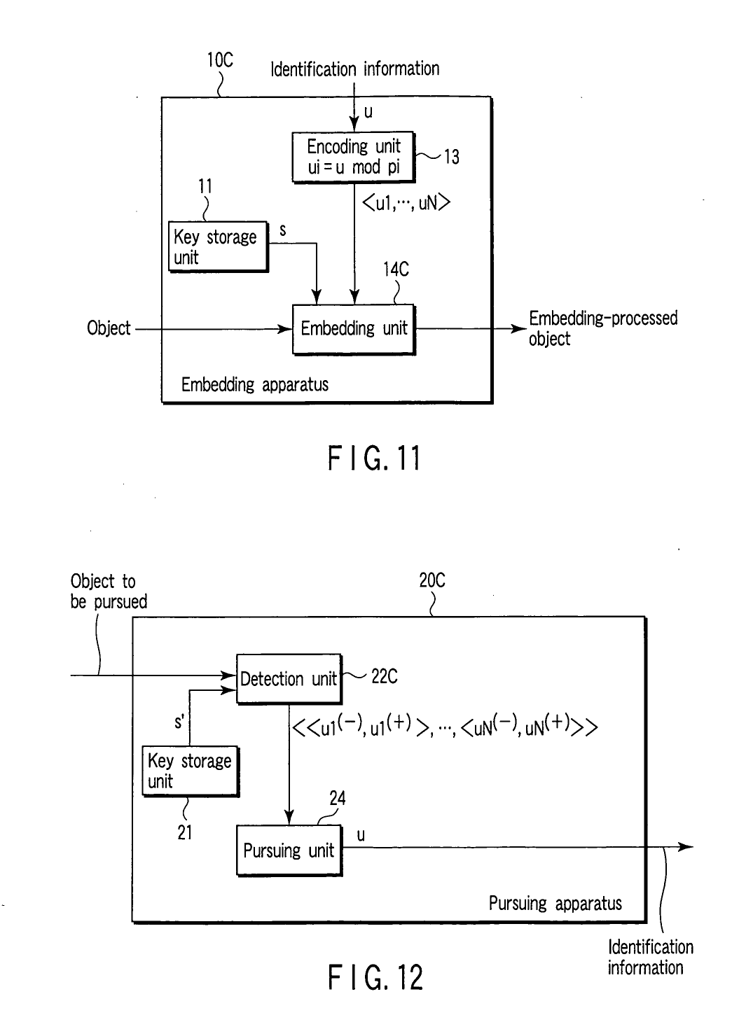

FIG. 11 shows a schematic view indicative of the configuration of an embedding apparatus according to the third embodiment of the present invention. FIG. 12 shows a schematic view indicative of the configuration of a pursuing apparatus according to the same embodiment. An embedding apparatus 10C shown in FIG. 11 and a pursuing apparatus 20C shown in FIG. 12 configure a system for pursuing an object, as is similar to that shown in FIG. 2.

That is, the third embodiment is the variation of the first embodiment, in which the secret key s is used in digital watermark embedding processing instead of encrypting the identification number u.

Accordingly, the embedding apparatus 10C does not include the encryption unit 12, while includes an embedding unit 14C that can read out the secret key s stored in the key storage unit 11. The encoding unit 13 has the same function as that explained in the first embodiment.

The embedding unit 14C is provided with the function of generating a random number string rj depending on the secret key s in addition to above described functions of the embedding unit 14. In this generation, it is desired that the cross-correlation between random number strings rj which are generated using different secret keys s be small. For example, it is desired that random numbers be generated using a linear feedback register with the secret key s set to be the initial value thereof. Furthermore, in embedding the embedding code w into content information, the embedding unit 14C does not combine “1” and “0” within the respective component codes w1, w2, . . . , wN.

On the other hand, the pursuing apparatus 20C does not include the decryption unit 24, while includes a detection unit 22C that can read out the secret key s′ stored in the key storage unit 21. The pursuing unit 23 has the same function as that explained in the first embodiment.

The pursuing apparatus 20C is provided with the function of generating a random number string rj depending on the secret key s′ in addition to above described functions of the detection unit 22. The manner of generating the random number string rj is similar to that of the embedding unit 14C.

According to above-described embodiment, when embedding the remainder codes <u1, u2, . . . , uN> which represent the identification number u of the user into content information as the embedding code w including strings of “1” and strings of “0”, the pseudorandom numbers rj generated based on the secret key s is added to or subtracted from the content information depending on the “1”, “0” of the embedding code w. By thus embedding the embedding code w into content information, the identification information u that is embedded by the fingerprinting scheme cannot be read out by the third party, which can protect privacy of the user.

Furthermore, since the pursuing apparatus 20C generates the pseudorandom numbers rj based on the secret key s′, and determines “1”, “0” of the embedding code w embedded in content information using above-described cross-correlation, the embedding code w can be read out from content information without problems. Furthermore, since the identification number u can be restored based on the respective remainder pairs of the remainder pair codes <<u1(−), u1(+)>, . . . , <uN(−), uN(+)>> obtained from thus determined embedding code w, the identification information u, which cannot be read out by the third party, can be read out by the pursuing apparatus 20C.

This embodiment can be varied by combining the first embodiment or the second embodiment therewith. According to these variations, effects of thus combined respective embodiments can also be obtained. These variations can be applied to the following respective embodiments.

### FOURTH EMBODIMENT

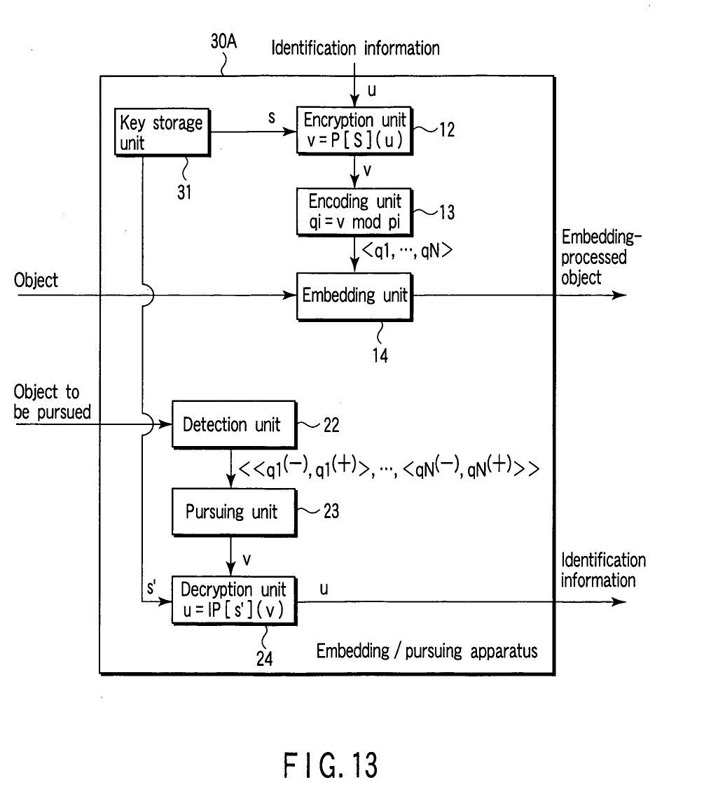

FIG. 13 shows a schematic view indicative of the configuration of an embedding/pursuing apparatus according to the fourth embodiment of the present invention.

The fourth embodiment is the variation of the first embodiment, which includes, instead of the independent embedding apparatus 10A and pursuing apparatus 20A, an embedding/pursuing apparatus 30A provided with the functions thereof in an identical apparatus. Accordingly, a key storage unit 31 is arranged instead of the key storage unit 11 and key storage unit 21.

The key storage unit 31 is a memory that stores therein secret keys s, s′, which can be read out by the encryption unit 12 as well as decryption unit 24. The secret keys s, s′ may be generated within the embedding/pursuing apparatus 30A, or may be transmitted from outside.

According to above-described embodiment, an effect of sharing the secret keys s, s′ within the embedding/pursuing apparatus 30A without distributing them to outside can be obtained in addition to the effects of the first embodiment.

The key storage unit 31 of this embodiment can be varied as follows. That is, the key storage unit 31 stores encrypted secret keys s, s′, and when they are required to be read out by the encryption unit 12 or decryption unit 24, the encrypted secret keys s, s′ are decrypted to be read out thereto. In this variation, the security of the secret keys s, s′ can be improved. This variation can be applied to the following respective embodiments.

### FIFTH EMBODIMENT

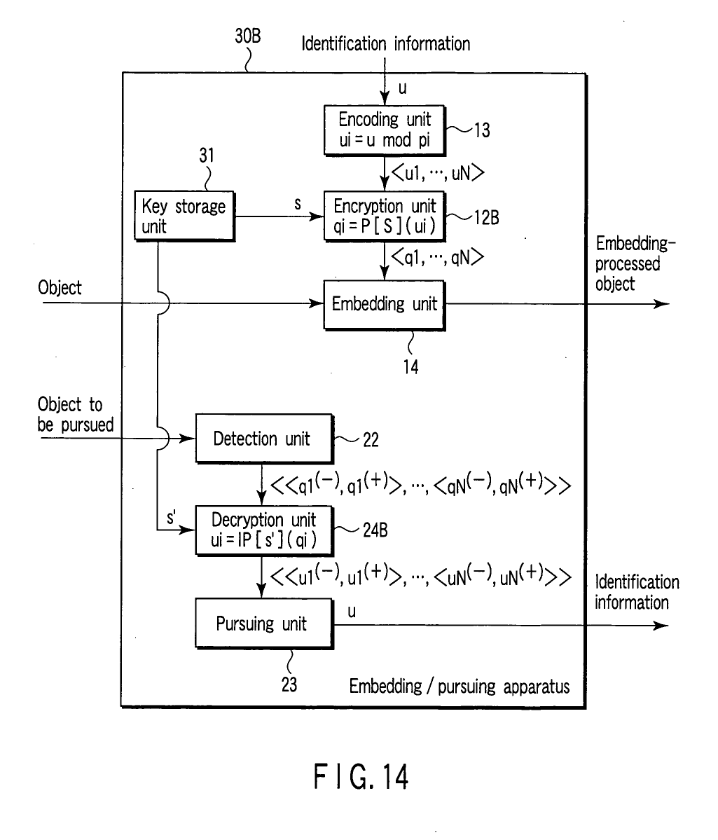

FIG. 14 shows a schematic view indicative of the configuration of an embedding/pursuing apparatus according to the fifth embodiment of the present invention.

The fifth embodiment is the variation of the second embodiment, which includes, instead of the independent embedding apparatus 10B and pursuing apparatus 20B, an embedding/pursuing apparatus 30B provided with the functions thereof in an identical apparatus. Accordingly, above-described key storage unit 31 is arranged instead of the key storage unit 11 and key storage unit 21.

According to above-described embodiment, effects of the fourth embodiment can be obtained in addition to the effects of the second embodiment.

### SIXTH EMBODIMENT

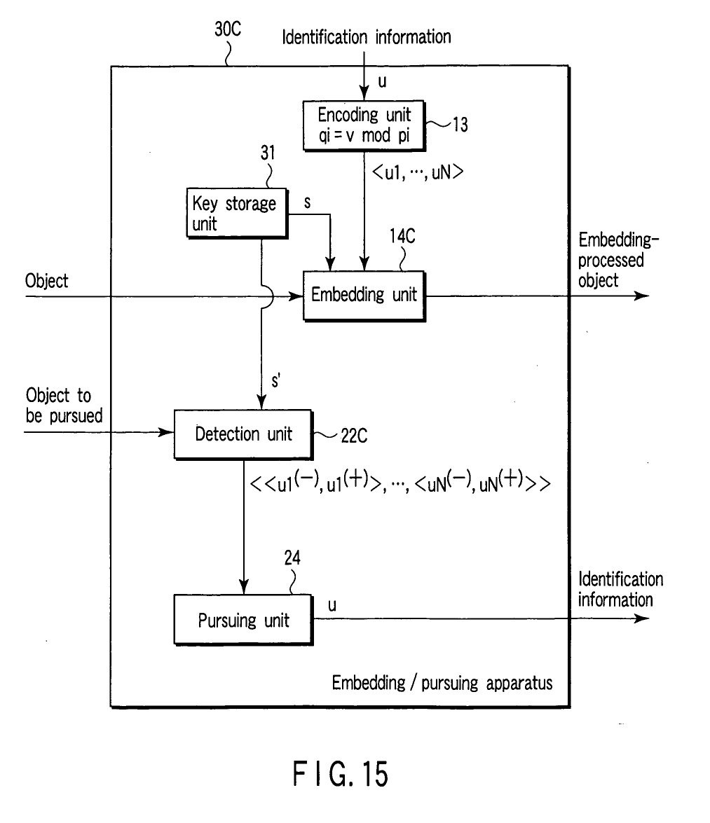

FIG. 15 shows a schematic view indicative of the configuration of an embedding/pursuing apparatus according to the sixth embodiment of the present invention.

The sixth embodiment is the variation of the third embodiment, which includes, instead of the independent embedding apparatus 10C and pursuing apparatus 20C, an embedding/pursuing apparatus 30C provided with the functions thereof in an identical apparatus. Accordingly, above-described key storage unit 31 is arranged instead of the key storage unit 11 and key storage unit 21.

According to above-described embodiment, effects of the fourth embodiment can be obtained in addition to the effects of the third embodiment.

In above-described methods, as the c-secure CRT encoding, an example configured on the rational integer ring is described. On the other hand, similar effects can be obtained in examples configured on the polynomial ring, and generally, the Dedekind ring.

Note that techniques described in the above-described respective embodiments can be stored as programs which can be executed by computers in storage media such as a magnetic disk (a floppy [registered trademark] disk, a hard disk, or the like), an optical disk (a CD-ROM, a DVD, or the like), an magneto-optical disk (MO), a semiconductor memory, or the like, and can be distributed.

As the storage media, if it is a storage medium in which the programs can be stored, and which can be read by computers, the storage system may be in any format. Some of the respective processings for realizing the present embodiments may be executed by an OS (operating system) which operates the computer on the basis of instructions from the program installed in the computer from the storage medium, middleware such as a database management software, a network software, or the like.

The storage medium in the present invention is not limited to a medium independent of the computer, and storage media which have downloaded and stored, or temporarily stored programs transmitted through a LAN, the Internet, or the like are included. The storage medium is not limited to one, and the case in which the processings in the present embodiment are executed through a plurality of storage media is included in the storage media in the present invention, and the medium configuration may be any configuration.

Note that, the computer in the present invention executes the respective processings in the present embodiment on the basis of a program stored in a storage medium, and may be any configuration of an apparatus formed from one such as a personal computer or the like, a system in which a plurality of devices are connected to a network, and the like. The computer in the present invention is not limited to a personal computer, and includes an arithmetic processing unit included in an information processing device, a micro-computer, or the like, and is the general term for devices and apparatuses which can realize the functions of the present invention by the programs.

Note that the present invention is not limited to the above-described embodiments as are, and structural requirements can be modified and materialized within a range which does not deviate from the gist of the present invention at the practical phase. Further, various inventions can be formed due to the plurality of structural requirements which have been disclosed in the above-described embodiments being appropriately combined. For example, several structural requirements may be eliminated from all of the structural requirements shown in the embodiments. Moreover, structural requirements over different embodiments may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A method for embedding codes which encodes an identification number of a user to embed thus obtained codes into content information, comprising:
preparing a secret key;
converting the identification number to remainder codes composed of a plurality of remainders to represent the identification number by a remainder system;
encrypting, during the conversion, the identification number or remainder codes based on the secret key; and
embedding the remainder codes obtained by the conversion into content information by digital watermark embedding processing.

2. The method for embedding codes according to claim 1, wherein
the encryption processing is a permutation processing based on pseudorandom numbers.

3. A method for embedding codes which encodes an identification number of a user to embed thus obtained codes into content information, comprising:
converting the identification number to remainder codes composed of a plurality of remainders to represent the identification number by a remainder system;
generating, from the remainder codes, a plurality of component codes composed of successive strings of “1” and strings of “0” which represent the respective remainders;
concatenating the respective component codes to generate an embedding code;
preparing a secret key;
generating a plurality of pseudorandom numbers based on the secret key; and
embedding the embedding code into content information such that other information is not combined within the respective component codes by adding or subtracting the respective pseudorandom numbers to or from content information based on “1” or “0” of the embedding code.

4. A method for restoring identification information which restores an identification number from content information in which remainder codes after encryption processing is embedded as an embedding code which is generated by concatenating respective component codes, the encryption processing encrypting, when converting the identification number of a user to the remainder codes composed of a plurality of remainders to represent the identification number by the remainder system, the identification number or remainder codes, comprising:
preparing a secret key for decryption processing corresponding to the encryption processing;
extracting an embedding code from the content information;
dividing thus extracted embedding code into respective component codes;
generating, for the respective component codes, a remainder pair representing the upper and lower limit of the remainder which thus divided each component code represents;
restoring an identification number using the Chinese Remainder Theorem based on the generated respective remainder pairs; and
decrypting, during the restoration, the respective remainder pairs or identification number based on the secret key.

5. The method for restoring identification information according to claim 4, wherein the decryption processing is a permutation processing based on pseudorandom numbers retained in advance.

6. The method for restoring identification information according to claim 4, wherein when extracting an embedding code from the content information, comprising:
generating a plurality of pseudorandom numbers based on the secret key;
calculating cross-correlation between content information in which the embedding code is embedded and the pseudorandom numbers; and
determining, based on the calculation result of the cross-correlation, whether the embedding code embedded in the content information is “1” or “0”.

7. An encoding device which encodes an identification number of a user in content information by remainder codes having a plurality of remainders by calculating remainders modulo a plurality of integers which are relatively prime respectively, comprising:
a secret key storage device configured to store therein a secret key; and
an encryption device configured to encrypt the identification number or remainder codes based on the secret key stored in the secret key storage device.

8. The encoding device according to claim 7, wherein
when remainder codes are to be encrypted, the encryption device encrypts the remainder codes such that the respective remainders of the remainder codes are not diminished.

9. An apparatus for embedding codes which has the encoding device according to claim 7, further comprising:
an embedding device configured to embed remainder codes sent from the encoding device into content information by digital watermark embedding processing.

10. The apparatus for embedding codes according to claim 9, wherein
the embedding device comprises:
a component code generation device configured to generate a plurality of component codes representing the respective remainders of the remainder codes;
a concatenation device configured to concatenate the respective component codes generated by the component code generation device to generate an embedding code; and
a digital watermark embedding device configured to embed the embedding code generated by the concatenation device into content information by digital watermark embedding processing.

11. The apparatus for embedding codes according to claim 10, wherein
the component code generation device generates codes composed of successive strings of “1” and strings of “0” with a predetermined number of bits set to be one unit as the respective component codes.

12. The apparatus for embedding codes according to claim 11, wherein
when the number of modulos is N, positive integer less than N is N′, positive integer equal to 2 or more is c, positive integer equal to 1 or more is z, the number of identification numbers which can be detected from the respective component codes at the time of detecting the embedding code is q, the relation of the number of modulos N≧c(N′+z)/2 is satisfied; and
each component code is a c-secure CRT code that can detect c identification numbers other than the identification number of the user from content information at the time of detecting the embedding code.

13. An apparatus for embedding codes which embeds remainder codes composed of a plurality of remainders to represent an identification number of a user by the remainder system into content information as an embedding code in which respective component codes composed of successive strings of “1” and strings of “0” which represent the respective remainders are concatenated, comprising:
a secret key storage device configured to store therein a secret key;
a pseudorandom number generation device configured to generate a plurality of pseudorandom numbers based on the secret key stored in the secret key storage device; and
an embedding device configured to embed the embedding code into content information by adding or subtracting the respective pseudorandom numbers to or from content information based on “1” or “0” of the embedding code.

14. An apparatus for detecting codes which detects embedded remainder codes from content information in which remainder codes after encryption processing is embedded as an embedding code which is generated by concatenating respective component codes by digital watermark embedding processing, the encryption processing encrypting, when converting the identification number of a user to the remainder codes composed of a plurality of remainders to represent the identification number by the remainder system, the identification number or remainder codes, comprising:
a code extraction device configured to extract an embedding code from the content information;
a code division device configured to divide thus extracted embedding code into respective component codes;
a remainder pair generation device configured to generate, for the respective component codes, a remainder pair representing the upper and lower limit of the remainder which thus divided each component code represents; and
a remainder pair code output device configured to output remainder pair codes composed of remainder pairs of the respective component codes.

15. An apparatus for restoring identification information which has the apparatus for detecting codes according to claim 14, comprising:
a secret key storage device configured to store therein a secret key for decryption processing corresponding to the encryption processing; and
a restoration device configured to restore an identification number using the Chinese Remainder Theorem based on the respective remainder pairs of the remainder pair codes output from the apparatus for detecting codes, wherein
the restoration device comprises a decryption device configured to decrypt the respective remainder pairs before restoration by the Chinese Remainder Theorem, or the identification number after restoration by the Chinese Remainder Theorem, based on the secret key stored in the secret key storage device.

16. The apparatus for restoring identification information according to claim 15, comprising:
a key exchange device configured to receive a secret key for decryption processing corresponding to the encryption processing from the encryption device by performing a key exchange protocol that uses public key infrastructure together with the encryption device for performing the encryption processing;
a key writing device configured to write the secret key sent from the key exchange device to the secret key storage device.

17. The apparatus for restoring identification information according to claim 15, comprising:
an encryption device for performing the encryption processing, wherein
the secret key storage device can be read out from the encryption device as well as the restoration device.

18. An apparatus for detecting codes which detects an embedding code from content information in which the embedding code is embedded by converting remainder codes composed of a plurality of remainders to represent an identification number of a user by the remainder system to the embedding code in which respective component codes composed of successive strings of “1” and strings of “0” which represent the respective remainders are concatenated, and by adding or subtracting pseudorandom numbers generated from a secret key in advance to or from the content information based on “1” or “0” of the embedding code comprising:
a secret key storage device configured to store therein a secret key;
a pseudorandom number generation device configured to generate a plurality of pseudorandom numbers based on the secret key stored in the secret key storage device;
cross-correlation calculation device configured to calculate cross-correlation between content information in which the embedding code is embedded and the pseudo-random numbers; and
an embedding code determination device configured to determine, based on the calculation result of the cross-correlation, whether the embedding code embedded in the content information is “1” or “0”.

19. The apparatus for detecting codes according to claim 18, comprising:
a code division device configured to divide the embedding code determined by the embedding code determination device into respective component codes;
a remainder pair generation device configured to generate, for the respective component codes, a remainder pair representing the upper and lower limit of the remainder which thus divided each component code represents; and
a remainder pair code output device configured to output remainder pair codes composed of remainder pairs of the respective component codes.

20. An apparatus for restoring identification information which has the apparatus for detecting codes according to claim 19, comprising:
a restoration device configured to restore an identification number using the Chinese Remainder Theorem based on the respective remainder pairs of the remainder pair codes output from the apparatus for detecting codes.
